(19) United States
(12) Patent Application Publication
(10) Pub. No.: US 2026/0109803 A1
(43) Pub. Date: Apr. 23, 2026

(54) SPRAYING AGENT AND RESIN SHEET

(71) Applicants: artience Co., Ltd., Chuo-ku, Tokyo (JP); TOYOCHEM CO., LTD., Chuo-ku, Tokyo (JP); TOYO INK CO., LTD., Chuo-ku, Tokyo (JP)

(72) Inventors: Naoki KISHIMOTO, Chuo-ku, Tokyo (JP); Toru OYA, Chuo-ku, Tokyo (JP); Wataru SHIKIJI, Chuo-ku, Tokyo (JP)

(73) Assignees: artience Co., Ltd., Chuo-ku, Tokyo (JP); TOYOCHEM CO., LTD., Chuo-ku, Tokyo (JP); TOYO INK CO., LTD., Chuo-ku, Tokyo (JP)

(21) Appl. No.: 19/168,479

(22) PCT Filed: Mar. 21, 2024
(86) PCT No.: PCT/JP2024/011092

§ 371 Date: Sep. 24, 2025

(30) Foreign Application Priority Data
Mar. 28, 2023 (JP) 2023-051761
Nov. 6, 2023 (JP) 2023-189029

(51) Int. Cl. C08G 18/12; A01N 25/04; A01N 25/24; C05G 3/80; C08G 18/32; C08G 18/75; C08J 5/18; C09K 17/30

(52) U.S. Cl. CPC C08G 18/12; A01N 25/04; A01N 25/24; C05G 3/80; C08G 18/3228; C08G 18/755; C08J 5/18; C09K 17/30; C08G 2230/00; C08G 2310/00; C08J 2375/12

(57) ABSTRACT

A spraying agent that includes a resin emulsion, and is used for at least one of agglomeration of soil, immobilization of seeds or plants, and immobilization of a chemical agent, in which the resin emulsion includes a biodegradable resin containing an ester skeleton and having a minimum film-forming temperature of 30° C. or lower. Further, a resin sheet that is formed of a resin composition containing the above-described resin emulsion.

### TECHNICAL FIELD

The present disclosure relates to a spraying agent and a resin sheet.

### BACKGROUND

Japanese Unexamined Patent Application Publication No. 2019-218207 discloses a dust scattering preventing agent for preventing dust from being scattered by spraying it on the surface layer of the soil.

### SUMMARY

In recent years, as a part of global warming countermeasures, a lot of efforts have been made to achieve carbon neutrality by preventing an excessive amount of carbon dioxide form being released. However, it is extremely difficult to completely eliminate emissions of carbon dioxide resulting from social activities. Therefore, efforts to reduce emissions of carbon dioxide as a whole by using “negative emissions technologies (NETs: Negative Emissions Technologies)” by which carbon dioxide in the atmosphere is recovered or absorbed, i.e., carbon dioxide is negatively emitted, are attracting attention.

An example of NETs is efforts to increase absorption of carbon dioxide by greening degraded land. As a greening method, a seed spraying method is suitable to spray seeds over a large area. However, when seeds are just sprayed, most of the seeds are blown away before germinating by wind and rain, so that there is a possibility that the area of interest cannot be sufficiently greened. Therefore, in the seed spraying method, a method in which an immobilizing agent is mixed in the dispersion liquid in which seeds are dispersed, and then the mixed dispersion liquid is sprayed is typically used. By spraying the dispersion liquid together with the immobilizing agent, the seeds can be sufficiently immobilized in the degraded land.

In the past, acrylic resins, ethylene-vinyl acetate copolymers, and the like are used as immobilizing agents. These resins are hardly biodegradable, so they are not decomposed after being sprayed and remain in the soil for a long time, so that they may adversely affect the environment. Further, after the resins are disassembled by the irradiation of ultraviolet rays or the like, they may be discharged into rivers and oceans by wind and rain, so that they may also adversely affect the ecosystem in the form of microplastics.

Japanese Unexamined Patent Application Publication No. 2019-218207 discloses a dust scattering preventing agent for preventing dust from being scattered by spraying it on the surface layer of the soil. This dust scattering preventing agent uses polylactic acid, which is a biodegradable resin, and a thickener such as polysaccharide, which serves as a film forming aid, in combination. The thickener gives a moderate viscosity to the hard polylactic acid, so that a film made of the resin can be formed on the surface layer of the soil.

By using the dust scattering preventing agent disclosed in Japanese Unexamined Patent Application Publication No. 2019-218207 as an immobilizing agent, it is expected to contribute to the greening of degraded land with consideration given to the environment. However, in the case of a combination of polylactic acid and a thickener, the fluidity of the thickener is high, so that, due to the softening, the film strength may be lowered and/or the thickener may bleed into the surface layer of the film, in particular, under a high temperature and rainy environment in summer, and the scattering prevention property may not be maintained for a long time.

The present disclosure has been made in view of these problems, and provides a spraying agent and a resin sheet having all of biodegradability, a film-forming property, a barrier property, and durability.

A spraying agent according to the present disclosure includes a resin emulsion, and is used for at least one of agglomeration of soil, immobilization of seeds or plants, and immobilization of a chemical agent, in which the resin emulsion includes a biodegradable resin containing an ester skeleton and having a minimum film-forming temperature of 30° C. or lower.

A resin sheet according to the present disclosure is a resin sheet formed of a resin composition containing a resin emulsion, and used for at least one of agglomeration of soil, immobilization of seeds or plants, and immobilization of a chemical agent, in which the resin emulsion includes a biodegradable resin containing an ester skeleton and having a minimum film-forming temperature of 30° C. or lower.

According to the present disclosure, it is possible to provide a spraying agent and a resin sheet having all of biodegradability, a film-forming property, a barrier property, and durability.

### BRIEF DESCRIPTION OF DRAWINGS

FIG. 1A is an explanatory diagram of immobilization of seeds using a spraying agent according to the present disclosure;

FIG. 1B is an explanatory diagram of immobilization of seeds using a spraying agent according to the present disclosure; and

FIG. 1C is an explanatory diagram of immobilization of seeds using a spraying agent according to the present disclosure.

### DETAILED DESCRIPTION OF EMBODIMENTS

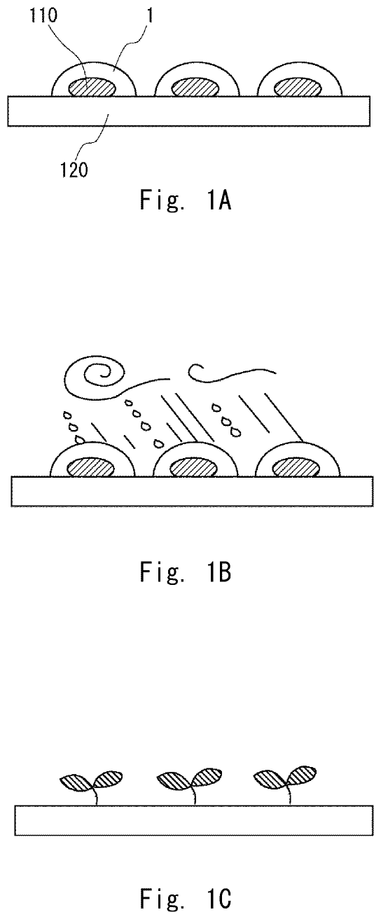

The present disclosure will be described hereinafter with reference to the drawings. FIGS. 1A to 1C show immobilization of seeds using a spraying agent according to the present disclosure. A spraying agent 1 contains a resin emulsion containing a biodegradable resin. The resin emulsion is a dispersion liquid in which a resin is dispersed in a dispersion medium. The main component of the dispersion medium is preferably water. Details of the biodegradable resin will be described later.

FIG. 1A shows a state in which the spraying agent 1 is sprayed onto soil 120 and seeds 110 are thereby immobilized. Note that the spraying agent 1 may be sprayed in a state in which seeds 110 are already sown on the soil 120, or the spraying agent 1 in which seeds 110 are mixed in advance may be sprayed on the soil 120. As the spraying agent 1 sprayed on the soil 120 dries, the biodegradable resin contained in the spraying agent 1 solidifies and immobilizes the seeds 110 on the soil 120.

FIG. 1B shows a state in which the surface of the soil 120 is exposed to wind and rain. Since the solidified biodegradable resin has a high water resistance, it can prevent erosion and/or effusion to the soil 120, which would otherwise be caused by wind and rain, until the seeds 110 germinate.

FIG. 1C shows a state in which the biodegradable resin has been decomposed and the seeds 110, which have been immobilized, have germinated. In this way, the spraying agent 1, which serves as an immobilizing agent, immobilizes the seeds 110 on the soil 120. Further, as will be described later, the spraying agent 1 has high biodegradability, so the burden on the environment is small. Note that in FIGS. 1A to 1C, the spraying agent 1 may completely cover the seeds 110. However, the above-described effects can be achieved even in a state in which a component(s) of the spraying agent 1 covers only parts of the seeds 110.

The biodegradable resin contained in the resin emulsion contained in the spraying agent 1 contains an ester skeleton. The ratio of the biodegradable resin to the 100 mass % of the resin component of the resin emulsion is preferably 1 to 100 mass % and more preferably 10 to 100 mass %. Further, the biodegradable resin preferably contains a urethane bond.

The biodegradable resin is a resin that contains an ester skeleton and has biodegradability. By having the ester skeleton, it can form a strong film. Further, by having biodegradability, the influence of the biodegradable resin on the environment can be reduced even when it is used outdoors.

The breaking strength of the film of the biodegradable resin is preferably 0.05 to 45 MPa, and the breaking elongation thereof is preferably 50 to 2,000%. When the breaking strength and breaking elongation are within the above-described ranges, the adhesion to the substrate is improved, so that seeds and the like can be firmly immobilized on the substrate. The breaking strength retention rate of the film of the biodegradable resin is preferably 70% or higher after it is kept for 20 days under an environment of a temperature of 40° C. and a humidity of 85%. When the breaking strength retention rate of the film is within the above-described range, the seeds can be continuously immobilized on the substrate for a sufficient period of time (e.g., a sufficient period of time until the seeds germinate).

The minimum film-forming temperature of the biodegradable resin is 30° C. or lower. Therefore, the resin emulsion can be film-formed and immobilized at a room temperature.

For example, the glass transition temperature (Tg) of polylactic acid or polycaprolactone exceeds 30° C., so that its film-forming property at a room temperature is poor. It is possible to impart a film-forming property to these resins by adding an appropriate amount of a plasticizer as a film forming aid. However, under a high temperature and rainy environment, in particular, the film strength may be lowered due to the softening of the plasticizer and the hardening and embrittlement of the film due to the bleeding of the plasticizer into the surface of the film or the diffusion thereof into the ground.

Examples of plasticizers include phthalate ester plasticizers, phosphate ester plasticizers, fatty acid ester plasticizers, adipate ester plasticizers, polyester plasticizers, and epoxy plasticizers; water-soluble natural components such as guar gum; water-soluble synthetic resin components such as polyvinyl alcohol and water-soluble acrylic resin; and surfactants.

The biodegradable resin may be used in combination with a plasticizer in a range in which its performance is not impaired, but no plasticizer is preferably used in combination.

Examples of biodegradable resins include an aliphatic polyester obtained by ring-opening polymerization of a cyclic ester and a biodegradable polyester urethane resin. The biodegradable resin is preferably a biodegradable polyester urethane resin. Biodegradable polyester urethane containing an ester skeleton and a urethane bond impart high strength and high flexibility to the film after being dried, and therefore has an excellent immobilization ability.

The aliphatic polyester obtained by ring-opening polymerization of a cyclic ester can be obtained by, for example, ring-opening polymerization of a cyclic ester using a hydroxyl group-containing compound as an initiator.

The cyclic ester is not limited to any particular compounds as long as it is a cyclic compound having at least one ester group in the molecule. Examples of cyclic esters include lactones and cyclic diesters.

Examples of lactones include β-propiolactone, β-butyrolactone, γ-butyrolactone, γ-hexanolactone, γ-octanolactone, δ-valerolactone, γ-valerolactone, δ-hexalanolactone, δ-octanolactone, ε-caprolactone, δ-dodecanolactone, α-methyl-γ-butyrolactone, β-methyl-δ-valerolactone, glycolide, and p-dioxanone.

Examples of cyclic diesters include D-lactide, L-lactide, DL-lactide, and mesolactide.

Among them, ε-caprolactone, D-lactide, L-lactide, DL-lactide, mesolactide, and the like are preferred. The film-forming property is improved by using these compounds.

The hydroxyl group-containing compound is not limited to any particular substances as long as it is a substance having a hydroxyl group. In view of the aqueous conversion step, the hydroxyl group-containing compound is preferably a compound having a carboxy group, polyethylene glycol, a compound having a sulfonic acid group, or the like, and particularly preferably dihydroxycarboxylic acid or the like. The dihydroxycarboxylic acid is not limited to any particular compounds as long as it has two or more hydroxyl groups and one or more carboxylic acids in the molecule. Examples include dimethylolpropanoic acid (DMPA), dimethylolbutanoic acid (DMBA), dimethylolpentanoic acid, dimethylolnonanoic acid, tartaric acid, 3,4,5-trihydroxybenzoic acid, 2,3,4-trihydroxybenzoic acid, 2,4,6-trihydroxybenzoic acid, mevalonic acid, pantoic acid, and glyceric acid. The dihydroxycarboxylic acid is preferably dimethylolpropanoic acid (DMPA), dimethylolbutanoic acid (DMBA), tartaric acid, or the like, and more preferably, dimethylolpropanoic acid (DMPA), dimethylolbutanoic acid (DMBA), or the like. By using tartaric acid, dimethylolpropanoic acid (DMPA), dimethylolbutanoic acid (DMBA), or the like, the aqueous conversion of the resin becomes easy and the dispersion stability in water is improved.

The biodegradable polyester urethane resin can be obtained by reacting a biodegradable polyester polyol, a polyisocyanate, and as required other polyols and/or polyamines.

The biodegradable polyester polyol is not limited to any particular polyols as long as it is a biodegradable polyester polyol, and is preferably an aliphatic polyester obtained by ring-opening polymerization of the above-described biodegradable cyclic ester.

Examples of biodegradable polyester polyols other than the aliphatic polyester obtained by ring-opening polymerization of the above-described biodegradable cyclic ester include polyglycol polyol, polybutylene succinate polyol, polyhydroxyalkanoate polyol, and polyhydroxybutyrate polyol.

In addition to biodegradable polyester polyols, examples of other polyols that can be used in combination include:
polyester polyols obtained from condensates of low-molecular-weight diols such as ethylene glycol, 1,2-propylene glycol, 1,3-propylene glycol, 1,2-butylene glycol, 1,3-butylene glycol, 2,3-butylene glycol, 1,4-butylene glycol, 2-methyl-1,3-propylene glycol, neopentyl glycol, 3-methyl-1,5-pentanediol, 2,2,4-trimethyl-1,3-pentanediol, 2,4-diethyl-1,5-pentanediol, 2-ethyl-1,3-hexanediol, 2,2-dimethyl-3-hydroxypropyl-2′,2′-dimethyl-3′-hydroxypropanate, 2-n-butyl-2-ethyl-1,3-propanediol, 3-ethyl-1,5-pentanediol, 3-propyl-1,5-pentanediol, 2,2-diethyl-1,3-propanediol, 3-octyl-1,5-pentanediol, 1,3-bis(hydroxymethyl)cyclohexane, 1,4-bis(hydroxymethyl)cyclohexane, 1,4-bis(hydroxyethyl)cyclohexane, 1,4-bis(hydroxypropyl) cyclohexane, 1,4-bis(hydroxymethoxy) cyclohexane, 1,4-bis(hydroxyethoxy) cyclohexane, 2,2-bis(4-hydroxymethoxycyclohexyl) propane, 2,2-bis(4-hydroxyethoxycyclohexyl) propane, bis(4-hydroxycyclohexyl) methane, 2,2-bis(4-hydroxycyclohexyl) propane, 3(4), 8(9)-tricyclo [5.2.1.0] decanedimethanol, and bisphenol A, and/or low-molecular triols such as glycerin, trimethylolpropane, and pentaerythritol, and dibasic acids such as terephthalic acid, adipic acid, azelaic acid, sebatic acid, dimer acid, hydrogenated dimer acid, phthalic anhydride, isophthalic acid, and trimellitic acid;
polycarbonate polyols obtained by reacting the aforementioned low-molecular diols with dialkyl carbonates, alkylene carbonates, or diaryl carbonates;
polyolefin polyols such as hydroxyl group-containing polybutadiene, acid group-containing hydrogenated polybutadiene, hydroxyl group-containing polyisoprene, hydroxyl group-containing hydrogenated polyisoprene, hydroxyl group-containing chlorinated polypropylene, and hydroxyl group-containing chlorinated polyethylene;
castor oil polyols made from plant-derived oils;
polyether polyols such as polyethylene glycol, polypropylene glycol, poly(ethylene/propylene) glycol, and polytetramethylene glycol;
polyester polyols obtained by condensing one or more polyols selected from aliphatic diols such as ethylene glycol, 1,2-propylene glycol, 1,3-propylene glycol, 1,2-butylene glycol, 1,3-butylene glycol, 2,3-butylene glycol, 1,4-butylene glycol, 2-methyl-1,3-propylene glycol, neopentyl glycol, 3-methyl-1,5-pentanediol, 2,2,4-trimethyl-1,3-pentanediol, 2,4-diethyl-1,5-pentanediol, 2-ethyl-1,3-hexanediol, 2,2-dimethyl-3-hydroxypropyl-2′,2′-dimethyl-3′-hydroxypropanate, 2-n-butyl-2-ethyl-1,3-propanediol, 3-ethyl-1,5-pentanediol, 3-propyl-1,5-pentanediol, 2,2-diethyl-1,3-propanediol, and 3-octyl-1,5-pentanediol; alicyclic glycols such as 1,3-bis(hydroxymethyl)cyclohexane, 1,4-bis(hydroxymethyl)cyclohexane, 1,4-bis(hydroxyethyl)cyclohexane, 1,4-bis(hydroxypropyl)cyclohexane, 1,4-bis(hydroxymethoxy) cyclohexane, 1,4-bis(hydroxyethoxy) cyclohexane, 2,2-bis(4-hydroxymethoxycyclohexyl) propane, 2,2-bis(4-hydroxyethoxycyclohexyl) propane, bis(4-hydroxycyclohexyl) methane, 2,2-bis(4-hydroxycyclohexyl) propane, and 3(4), 8(9)-tricyclo [5.2.1.0] decanedimethanol; and aromatic glycols such as ethylene oxide or propylene oxide adducts to both terminal hydroxyl groups of bisphenol A, and dibasic acids having sulfonic acid metal bases (e.g., 5-sodium sulfosophthalic acid, 3-sodium sulfoterephthalic acid, and 4-potassium sulfo-1,8-naphthalenedicarboxylic anhydride).

Examples of polyisocyanates include:
aromatic polyisocyanates such as 2,4-tolylenediisocyanate, 2,6-tolylenediisocyanate, m-phenylenediisocyanate, p-phenylenediisocyanate, 4,4′-diphenylmethane diisocyanate, xylylenediisocyanate, lysine diisocyanate, 3,3′-dimethyl-4,4′-biphenylenediisocyanate, 3,3′-dimethoxy-4,4′-biphenylenediisocyanate, 3,3′-dichloro-4,4′-biphenylenediisocyanate, 1,5-naphthalenediisocyanate, and 1,5-tetrahydronaphthalenediisocyanate;
aliphatic polyisocyanates such as tetramethylene diisocyanate, hexamethylene diisocyanate, and trimethylhexamethylene diisocyanate; and
alicyclic polyisocyanates such as isophorone diisocyanate, 1,4-cyclohexylene diisocyanate, and 4,4′-dicyclohexylmethane diisocyanate.

The polyisocyanate is preferably hexamethylene diisocyanate, isophorone diisocyanate, or the like.

In the synthesis of the polyester urethane resin, a low-molecular diol may be used in combination in order to adjust the concentration of the urethane bond and/or introduce various functional groups.

The low-molecular diol is preferably a diol having a molecular weight of 500 or smaller. Examples of such diols include ethylene glycol, 1,2-propanediol, 1,3-propanediol, 1,3-butanediol, 1,4-butanediol, neopentyl glycol, pentanediol, hexanediol, octanediol, 2-butyl-2-ethyl-1,3-propanediol, 1,4-butylenediol, dipropylene glycol, glycerin, trimethylolpropane, trimethylolethane, 1,2,6-butanetriol, pentaerythritol, sorbitol, N,N-bis(2-hydroxypropyl) aniline; dimethylolalkanoic acids such as dimethylolacetic acid, dimethylolpropionic acid, dimethylolbutanoic acid, 2,2-dimethylolbutyric acid, and 2,2-dimethylolpentanoic acid; dihydroxysuccinic acid; dihydroxypropionic acid; and dihydroxybenzoic acid.

Among them, the low-molecular diol is preferably dimethylol alkanoic acids such as dimethylol acetic acid, dimethylol propionic acid, dimethylol butanoic acid, 2,2-dimethylol butyric acid, and 2,2-dimethylol pentanoic acid; dihydroxysuccinic acid; dihydroxypropionic acid; or dihydroxybenzoic acid or the like because the aqueous conversion can be easily carried out by having a carboxy group in the skeleton. Further, the low-molecular diol is more preferably dimethylol propionic acid, dimethylol butanoic acid, or the like.

The end of the polyester urethane resin may be modified, and/or its chain may be extended. Examples of compounds that can be used for the end modification and/or the chain extension reaction include aliphatic polyamines such as ethylenediamine, trimethylenediamine, diethylenetriamine, dipropylenetriamine and triethylenetetramine; alicyclic polyamines such as piperazine and isophorondiamine; and aromatic polyamines such as 4,4′-diphenylmethanediamine and metaxylenediamine. Only one of them may be used alone, or two or more of them may be used in combination.

Examples of urethanizing catalysts include metal-based catalysts such as dibutyl tin dilaurate (DTD), alkyl titanate, organosilicon titanate, stannus octoate, lead octylate, zinc octylate, bismuth octylate, bismuth neodecanoate, dibutyl tin diorthophenyl phenoxide, and reaction products of tin oxide with ester compounds (such as dioctyl phthalate); and amine-based catalysts such as monoamines (such as triethylamine), diamines (such as N,N,N′,N′-tetramethylethylene diamine), triamines (such as N,N,N′,N″,N″-pentamethyldiethylene triamine), and cyclic amines (such as triethylene diamine).

In the synthesis of polyester urethane resin, one or more organic solvents may be used. Examples of organic solvents include aliphatic hydrocarbons such as octane; alicyclic hydrocarbons such as cyclohexane and methylcyclohexane; ketones such as methyl isobutyl ketone, methyl ethyl ketone, and acetone; esters such as ethyl acetate and butyl acetate; glycol ether esters such as ethylene glycol ethyl ether acetate, propylene glycol monomethyl ether acetate, 3-methyl-3-methoxybutyl acetate, and ethyl-3-ethoxypropionate; ethers such as dioxane; halogenated hydrocarbons such as methylene iodide and monochlorobenzene; amide-based solvents such as N-methylpyrrolidone, dimethylformamide, dimethylacetamide, and hexamethylphosphonylamide; and dimethyl sulfoxide. The organic solvent is preferably acetone, methyl ethyl ketone, or the like.

When the polyester urethane resin has a carboxy group, it can be converted to an aqueous resin by neutralizing the carboxy group with a neutralizing agent. The neutralizing agent is not limited to any particular compounds, and examples include ammonia, organic amine compounds, and inorganic basic compounds. Examples of organic amine compounds include alkylamines such as triethylamine, isopropylamine, ethylamine, diethylamine, and sec-butylamine; alkoxyamines such as 3-ethoxypropylamine, propylamine, N,N-dimethylethanolamine, and 3-methoxypropylamine; alkanolamines such as N,N-diethylethanolamine, aminoethanolamine, N-methyl-N,N-diethanolamine, monoethanolamine, diethanolamine, and triethanolamine; and morpholines such as morpholine, N-methylmorpholine, and N-ethylmorpholine. The organic amine compound is preferably triethylamine, ammonia, or the like in view of the drying property.

Examples of the method for manufacturing a resin emulsion include a method in which a biodegradable resin is synthesized in an organic solvent or without a solvent, and then it is dispersed in water by using an emulsifier; and a method in which a hydrophilic group is introduced into a resin and is dispersed in water by self-emulsification.

The average particle diameter of particles in the resin emulsion is preferably 300 nm or smaller, and more preferably 200 nm or smaller. Further, the lower limit value of the average particle diameter is not limited to any particular values as long as the manufacturing is possible, and is preferably 10 nm and more preferably 50 nm. When the particle diameter is 300 nm or smaller, the dispersion stability becomes satisfactory; the precipitation hardly occurs even when it is stored for a long time; and the anchoring property to the substrate becomes satisfactory. Further, when the particle diameter is 10 nm or larger, the resin emulsion can be stably manufactured.

The solid content concentration of the resin emulsion is typically 10 to 70 mass %, and preferably 20 to 50 mass %. When the solid content concentration is 20 mass % or higher, it is possible to increase the film-thickness of the dried coating after the application, and thereby to obtain a strong coating. When the solid content concentration is 50 mass % or lower, a sufficient distance can be secured between particles in the resin emulsion, so that the dispersion stability becomes satisfactory.

The spaying agent according to the present disclosure may contain, as optional components other than the resin emulsion, one or more additives such as seeds of a plant, a fertilizer, a growth regulator, a pesticide, a flame retardant, a growth base material, a colorant, a clay mineral, soil, spores, fungi, a water retainer, an antifoam, a surfactant, an antiseptic, and a cross-linking agent.

Examples of seeds include seeds of herbaceous plants and woody plants.

Examples of fertilizers include organic fertilizers, inorganic fertilizers, and composite fertilizers.

Examples of growth regulators include rooting and root-taking promoters, flowering/fruiting/enlargement promoters, and elongation inhibitors.

Examples of pesticides include insecticides, fungicides, insecticidal fungicides, herbicides, rodenticides, and plant growth regulators.

Examples of flame retardants include halogen-based flame retardants, phosphorous flame retardants, and inorganic flame retardants.

Examples of growth base materials include bark compost; peat moss; compost such as pruned branches and leaves; on-side soil and sand; sandy soil; raw chips; composting chips; and fermented sludge compost.

Examples of colorants include organic pigments, inorganic pigments, and dyes.

Examples of clay minerals include kaolinite, smectite, serisalite, illite, gloconite, chlorite, talc, and zeolite.

Examples of soils include natural soil and artificial soil.

Examples of water retainers include highly absorbent polymers such as natural polymers and synthetic polymers.

Examples of antifoaming agents include polysiloxane-based antifoaming agents, mineral oil-based antifoaming agents, and nonionic surfactants. Among them, polysiloxane-based antifoaming agents are preferred in view of the potency of antifoaming. Examples of polysiloxane-based antifoaming agents include polysiloxane-based antifoaming agents containing a polymer having a polydimethylsiloxane structure and also containing, as required, additives such as hydrophobic silica and mineral oil.

Surfactants can be used to improve the wettability and/or the anchoring property of the biodegradable resin for the substrate. Examples include anionic surfactants, cationic surfactants, nonionic surfactants, and amphoteric surfactants. Anionic surfactants or nonionic surfactants are preferred in view of the safety and the development of satisfactory coating physical properties.

Examples of antiseptic agents include sodium dehydroacetate, dichlorophene, sorbic acid, sodium benzoate, p-hydroxybenzoate, and 1,2-benzisothiazoline-3-one (Product name: Proxel GXL, manufactured by Avicia).

As for the cross-linking agent, polyfunctional compounds reactive to a carboxy group are suitable. Examples include polyfunctional carbodiimides, polyfunctional isocyanates, polyfunctional epoxies, and polyfunctional oxazolines.

Various effects can be developed by applying a resin emulsion containing one or more biodegradable resins and, as required, one or more types of additives according to the present disclosure, or a spraying agent containing such a resin emulsion according to the present disclosure to a substrate.

Examples of the substrate include soil, rock, nonwoven fabric, a biodegradable film, paper, cloth, rope, concrete, cement, wood, leaves, grass, fruit, male flowers, and female flowers.

Examples of the method for an application include spray spraying, shower spraying, dipping, printing, an application by a brush, and dripping.

The resin emulsion containing the biodegradable resin according to the present disclosure can be used in arbitrary uses and is suitable as a spraying agent for greening. Example of other uses include an agent for preventing a plum of dust from rising from soil, a spraying agent for fire prevention, a spraying agent containing an herbicide, and an agent for immobilizing seaweed or spores.

The spraying agent according to the present disclosure can be used for various uses other than the use for immobilizing seeds on the soil. For example, by spraying the spraying agent according to the present disclosure on the soil, it is possible to facilitate the agglomeration of the soil and/or the prevention of the rising of a plum of dust from the soil. By using the spraying agent according to the present disclosure, it is possible to immobilize seeds and/or plants (vegetation organisms) not only on the soil but also on trees and leaves. By using the spraying agent according to the present disclosure, it is possible to immobilize a chemical agent such as a pesticide, a growth regulator, an herbicide, and an insect repellent by spraying the spraying agent on the soil, a field, and an exterior wall of a house. By using the spraying agent according to the present disclosure, it is possible to immobilize a flame retardant in a forest or on exterior walls of houses, and thereby to prevent the occurrence a fire and/or the spreading thereof.

A resin composition containing a resin emulsion according to the present disclosure can be dry-molded into and used in the form of a resin sheet, granules, or the like. For example, by manufacturing a resin sheet, granules, or the like, in which at least some of seeds, a part of fertilizer, a part of seaweed, or the like is covered with a biodegradable resin, and disposing it or them on the soil, seabed, or the like, and immobilizing the seeds, the fertilizer, the seaweed, or the like on the soil or the like, the place where it is (or they are) disposed can be easily greened. By using such a resin sheet or granules, the speed of germination, growth, and the like of plants can be easily controlled.

As described above, according to the present disclosure, it is possible to provide a spraying agent and a resin sheet having biodegradability, a barrier property, and durability.

### EXAMPLES

The present disclosure will be described in a more detailed manner by using the below-shown examples, but the present disclosure is not limited to these examples. In the following description, “%” in the unit for mixing amount and solid concentration is “mass %”, unless otherwise specified, and “part” in the unit for mixing amount is “pts.mass”, unless otherwise specified.

### Synthesis Example PE1

Firstly, 18.67 parts of ε-caprolactone as a cyclic ester component and 0.87 parts of dimethylolpropanoic acid as a dihydroxycarboxylic acid component were put into a reaction vessel equipped with a stirrer, a thermometer, and a refluxing device. Then, the temperature was raised to 180° C. while stirring the mixture under a nitrogen atmosphere, and they were reacted for five hours. After that, biodegradable polyol was obtained by distilling and removing the unreacted cyclic ester component while decompressing the atmosphere with a pump. The number average molecular weight of the obtained biodegradable polyol was 3,000.

After that, 1.31 parts of dimethylolpropanoic acid as polyol and 7.96 parts of isophorone diisocyanate as isocyanate were added, and they were reacted for five hours. As a result, a urethane prepolymer having an isocyanate group at the end was obtained. Next, the mixture was diluted by adding 20 parts of acetone, and then neutralized by adding 1.64 parts of triethylamine. Further, the mixture was stirred for one hour. After that, 68.8 parts of ion-exchanged water was added to the mixture while stirring it, and the urethane prepolymer was dispersed in water. After that, the temperature in the reaction vessel was set to 30° C., and a mixed solution of 0.7 parts of ethylenediamine as an organic amine and 5 parts of water was added little by little, and the mixture was stirred for five hours. After that, the internal temperature of the reaction vessel was raised to 50° C., and the acetone was distilled and removed while decompressing the atmosphere. In this process, a part of ion-exchanged water was distilled and removed together with the acetone. Lastly, ion exchange water was added so that the solid concentration became 30%, and a resin emulsion containing a biodegradable resin of interest was obtained.

### Synthesis Examples PE2 to PE12

The same procedures as that in Synthesis Example PE1 were performed, except that the types and amounts of biodegradable polyol, polyol, isocyanate, and organic amine were changed as shown in Table 1. As a result, resin emulsions shown in Table 1 were obtained.

TABLE 1

| | | Synthetic example | | | | | | |
|---|---|---|---|---|---|---|---|---|
| | | PE1 | PE2 | PE3 | PE4 | PE5 | PE6 | PE7 |
| Biodegraded | ε-caprolactone | 18.67 | 17.41 | 19.55 | 21.53 | 20.84 | 15.24 | 19.49 |
| polyol | Mesolactide | | | | | | | |
| | Dimethylolpropanoic acid | 0.87 | 0.81 | 0.55 | 1.01 | 0.48 | 1.10 | 0.45 |
| Total of biodegradable polyols | | 19.54 | 18.22 | 20.10 | 22.54 | 21.32 | 16.34 | 19.94 |
| polyol | PTMG2000 | | | | | | | |
| | Clarepolyol P2010 | | | | | | | |
| | Dimethylolpropanoic acid | 1.31 | 1.22 | 1.37 | 1.51 | 1.46 | 1.07 | 1.36 |
| Isocyanate | Isophorone diisocyanate | 7.96 | 9.05 | 7.82 | 5.38 | 6.25 | 10.67 | 7.80 |
| Organic amine | Ethylenediamine | 0.70 | 1.04 | 0.20 | 0.00 | 0.42 | 0.00 | 0.39 |
| | Diethylenetriamine | 0.00 | 0.00 | 0.00 | 0.00 | 0.00 | 1.52 | 0.00 |
| Dispersion | Water | 68.8 | 68.9 | 68.8 | 68.67 | 68.73 | 69.05 | 68.81 |
| medium | | | | | | | | |
| Neutralizing | Triethylamine | 1.64 | 1.53 | 1.71 | 1.90 | 1.82 | 1.36 | 1.70 |
| agent | | | | | | | | |

| | | | | | | | |
|---|---|---|---|---|---|---|---|
| Total | 100.0 | 100.0 | 100.0 | 100.0 | 100.0 | 100.0 | 100.0 |
| Degree of biodegradation | 63% | 59% | 66% | 73% | 71% | 51% | 66% |
| Minimum film formation temperature | ≤0° C. | ≤0° C. | ≤0° C. | ≤0° C. | ≤0° C. | 25° C. | ≤0° C. |
| Breaking strength (MPa) | 25 | 28 | 1 | 10 | 0.03 | 50 | 0.06 |
| Elongation at break | 600% | 200% | 1500% | 800% | 2200% | 45% | 1800% |

| | | Synthetic example | | | | |
|---|---|---|---|---|---|---|
| | | PE8 | PE9 | PE10 | PE11 | PE12 |
| Biodegraded | ε-caprolactone | 15.44 | 7.85 | 0.00 | 0.00 | 9.33 |
| polyol | Mesolactide | | | | | 9.33 |
| | Dimethylolpropanoic acid | 0.72 | 0.37 | 0.00 | 0.00 | 0.87 |
| Total of biodegradable polyols | | 16.16 | 8.22 | 0.00 | 0.00 | 19.5 |
| polyol | PTMG2000 | | | 15.60 | 0.00 | |
| | Clarepolyol P2010 | | | 0.00 | 15.60 | |
| | Dimethylolpropanoic acid | 1.08 | 3.93 | 1.87 | 1.87 | 1.31 |
| Isocyanate | Isophorone diisocyanate | 10.81 | 15.70 | 10.92 | 10.92 | 7.96 |
| Organic amine | Ethylenediamine | 0.00 | 1.18 | 1.18 | 1.18 | 0.70 |
| | Diethylenetriamine | 1.54 | 0.00 | 0.00 | 0.00 | 0.00 |
| Dispersion | Water | 69.05 | 67.73 | 69.01 | 69.01 | 68.8 |
| medium | | | | | | |
| Neutralizing | Triethylamine | 1.36 | 3.24 | 1.41 | 1.41 | 1.64 |
| agent | | | | | | |

| | | | | | |
|---|---|---|---|---|---|
| Total | 100.0 | 100.0 | 100.0 | 100.0 | 100.0 |
| Degree of biodegradation | 52% | 27% | 0% | 0% | 63% |
| Minimum film formation temperature | 20° C. | 25° C. | ≤0° C. | ≤0° C. | ≤0° C. |
| Breaking strength (MPa) | 40 | 8 | 30 | 32 | 20 |
| Elongation at break | 60% | 70% | 450% | 500% | 730% |

Abbreviations in Table 1 represent materials shown below:
PTMG (polytetramethylene ether glycol, manufactured by Mitsubishi

Chemical Group Corporation); and P2010 (polyester polyol, manufactured by Kuraray Co., Ltd.).

“≤0° C.” in Table 1 indicates 0° C. or lower.

### Examples E1 to E10, Comparative Examples EC1 to EC5

In Examples E1 to E10, resin emulsions obtained in Synthetic Examples PE1-PE9 or PE12 were used.

In Comparative Example EC1, a mixture of a polylactic acid emulsion and a phthalate ester plasticizer (PEs) was used.

In Comparative Example EC2, a polycaprolactone emulsion was used.

In Comparative Example EC3, a resin emulsion obtained in Synthetic Example PE10 was used.

In Comparative Example EC4, a resin emulsion obtained in Synthetic Example PE11 was used.

In Comparative Example EC5, a vinyl acetate-acrylate copolymer emulsion (Kuricoat C710 manufactured by Kurita Water Industries Ltd.) was used.

The following test was carried out in each of Examples E1 to E10 and Comparative Examples EC1 to EC5. Tables 1 and 2 show the results of the tests.

### <Coating Film Durability Test>

A coating having a thickness of 2 mm was manufactured by filling a sheet-like mold with a resin emulsion and drying it. The surface was smoothed and the coating was punched with a No. 3 dumbbell mold, and by doing so, a dumbbell-shaped test piece for evaluation was manufactured. By using this dumbbell piece, a tensile test was carried out at a tensile speed of 50 mm/min, and its breaking stress (MPa) and breaking elongation (%) were measured under an environment of 25° C. A dumbbell piece separately manufactured by a similar procedure was stored at 40° C. and a relative humidity of 85% for 20 days. After that, a tensile test was carried out at a tensile speed of 50 mm/min, and its breaking stress (MPa) and breaking elongation (%) were measured under an environment of 25° C. Under the definition that the breaking strength before the storage was 100%, the breaking strength retention rate of the breaking strength after the storage was evaluated.

### [Evaluation Criteria]

S: Breaking strength retention rate is 90% or higher (Excellent).
A: Breaking strength retention rate is 80% or higher and lower than 90% (Good).
B: Breaking strength retention rate is 70% or higher and lower than 80% (Acceptable).
C: Breaking strength retention rate is lower than 70% (Unacceptable).

### <Outdoor Exposure Test>

A resin emulsion was uniformly sprayed onto the surface of culture soil so that the solid weight of the resin became 40 g per square meter on the surface of the culture soil, and then dried at 25° C. After being dried, water was uniformly showered/sprinkled at a wind speed of 15 m/s and a flow rate of 10 L/min for 5 hours under an environment of 35° C. After that, the scattering condition of the culture soil was checked. The scattering test of the culture soil was evaluated by observing the surface of the culture soil according to the evaluation criteria shown below.

### [Evaluation Criteria]

S: No scattering of culture soil is recognized (Excellent).
A: Scattering of culture soil is slightly recognized (Good).
B: Scattering of culture soil is recognized (Acceptable).
C: Large amount of culture soil is scattered (Unacceptable).

### <Biodegradability Test>

A film having a thickness of 0.5 mm, a length of 10 cm, and a width of 10 cm was manufactured by drying the resin emulsion. Then, the film was buried in compost for one month. The volume of the obtained film was defined as 100%, and the ratio of the residue that could be visually observed after the test was calculated. Then, the calculated ratio of the residue was evaluated according to the evaluation criteria shown below.

### [Evaluation Criteria]

S: Residue that can be visually observed is less than 60% (Excellent).
A: Residue that can be visually observed is 60% or more and less than 70% (Good).
B: Residue that can be visually observed is 70% or more and less than 90% (Acceptable).
C: Residue that can be visually observed is 90% or more

### (Unacceptable).

### <Fire Prevention Incombustibility Test>

A spraying agent was produced by adding 20 parts of ammonium polyphosphate to 100 parts of the resin emulsion, and sprayed on 1 m² of grass (i.e., lawn) (Kentucky bluegrass). After 72 hours, water was uniformly showered/sprinkled at a flow rate of 10 L/min for 5 hours. After that, the grass was dried over 72 hours. After being dried, the part of the grass that was sprayed with the spraying agent was ignited by CR Chackka-man (manufactured by Tokai Corporation) for 3 seconds, and the degree of burning of the grass was evaluated.

### [Evaluation Criteria]

S: 80% or more of part of grass that came into contact with fire remains (Excellent).
A: 50% or more and less than 80% of part of grass that came into contact with fire remains (Good).
B: 10% or more and less than 50% of part of grass that came into contact with fire remains (Acceptable).
C: Less than 10% of part of grass that came into contact with fire remains (Unacceptable).

### <Herbicide Effect Maintenance Check>

A spraying agent was produced by mixing 1,000 parts of the resin emulsion with 20 parts of herbicide (Product name: Sunfulon, manufactured by Taiseinozai Co., ltd.). The produced spraying agent was sprayed on 20 m² of land where commelinaceae was in clusters so that the solution came into contact with the surfaces of leaves of commelinaceae. After five hours, water was uniformly showered/sprinkled at a flow rate of 10 L/min for 5 hours. Water was sprinkled once a day, and after two weeks, the state of commelinaceae was observed and evaluated.

### [Evaluation Criteria]

S: 80% or more of commelinaceae is withered (Excellent).
A: 50% or more and less than 80% of commelinaceae is withered (Good).
B: 20% or more and less than 50% of commelinaceae is withered (Acceptable).
C: Less than 20% of commelinaceae is withered (Unacceptable).

### <Species Growth Test>

A spraying agent was produced by mixing 3.4 parts of the resin emulsion in terms of solid content, 1.4 parts of seeds of grass (Kentucky bluegrass, available from Fukukaen Nursery & Bulb Co., Ltd.), 0.04 parts of Menedael grass fertilizer (manufactured by Menedael) as fertilizer, and 95.1 parts of water. Then, the produced splaying agent was sprayed on the soil at 3.5 kg/m². The soil was put in a planter, and the planter was tilted so that the surface of the soil was at an angle of 45° from the ground surface in order to reproduce a hypothetical slope environment. The planter was kept in a greenhouse having a room temperature of 35° C. Further, an environment of rain and wind was reproduced by uniformly showering/sprinkling water at a flow rate of 10 L/min for 5 hours and blowing air by a dryer (a wind speed of 10 m/s, 30 seconds) once a day. After one month, the growth state of the grass was evaluated.

S: 80% or more of soil is covered with grass under visual observation (Excellent).
A: 50% or more and less than 80% of soil is covered with grass under visual observation (Good).
B: 20% or more and less than 50% of soil is covered with grass under visual observation (Acceptable).
C: Less than 20% of soil is covered with grass under visual observation (Unacceptable).

### <Seaweed Immobilization Test>

Nine seedlings of seaweed (about 3 cm long, Meristotheca papulosa) were put in an area of 10 cm×10 cm on a concrete block. Then, the resin emulsion was sprayed on them, and the seedlings was dried at a room temperature for 24 hours, so that the seedlings were immobilized on the concrete block. After that, the concrete block on which the seedlings were immobilized was put in a square mesh fish cage (manufactured by Siyouei) and submerged 5 m from the surface of the sea. After that, they were left for one month, and then the degree of immobilization was checked.

### [Evaluation Criteria]

S: 7 to 9 seedings remain immobilized (Excellent).
A: 4 to 6 seedings remain immobilized (Good).
B: 1 to 3 seedings remain immobilized (Acceptable).
C: No seedings remain immobilized (Unacceptable).

TABLE 2

| | | Example | | | | | | | | | |
|---|---|---|---|---|---|---|---|---|---|---|---|
| | | E1 | E2 | E3 | E4 | E5 | E6 | E7 | E8 | E9 | E10 |
| Resin emulsion | | PE1 | PE2 | PE3 | PE4 | PE5 | PE6 | PE7 | PE8 | PE9 | PE12 |
| Evaluation | Film durability test | S | A | A | B | B | B | A | A | A | S |
| items | Outdoor exposure test | S | A | A | B | B | A | A | A | A | S |
| | Biodegradation test | S | S | S | A | A | B | S | A | B | S |
| | Fire prevention non- | S | S | A | B | B | A | A | A | A | A |
| | combustibility test | | | | | | | | | | |
| | Herbicide effect | S | S | A | B | B | B | A | A | A | A |
| | maintanence check | | | | | | | | | | |
| | Seed growth test | S | S | A | B | B | B | A | A | A | A |
| | Seaweed | S | A | A | B | B | B | A | A | A | S |
| | immobilization test | | | | | | | | | | |

| | | Comparative example | | | | |
|---|---|---|---|---|---|---|
| | | EC1 | EC2 | EC3 | EC4 | EC5 |
| Resin emulsion | | polylactic acid | polycaprolactone | PE10 | PE11 | Kuricoat |
| | | emulsion + | emulsion | | | C710 |
| | | PEs plasticizer | | | | |
| Evaluation | Film durability test | C | C | A | A | A |
| items | Outdoor exposure test | C | C | A | A | A |
| | Biodegradation test | S | S | C | C | C |
| | Fire prevention non- | C | C | A | A | A |
| | combustibility test | | | | | |
| | Herbicide effect | C | C | A | A | A |
| | maintanence check | | | | | |
| | Seed growth test | C | C | C | C | C |
| | Seaweed | C | C | C | C | C |
| | immobilization test | | | | | |

Although the present disclosure has been described with the above-described embodiments, the present disclosure is not limited to the configurations of the above-described embodiments. Further, needless to say, the present disclosure includes various modifications, corrections, and combinations that can be made by a person skilled in the art within the scope of the claims. Further, a resin emulsion containing a biodegradable resin according to the present disclosure is not limited to spraying agents used for greening, spraying agents for preventing a plum of dust from rising from soil, spraying agents for fire prevention, spraying agents containing an herbicide, and spraying agents for immobilizing seaweed or spores, but can also be suitably used as other spraying agents or immobilizers.

The present disclosure is to contribute to carbon neutrality, decarbonization, and sustainable development goals (SDGs: Sustainable Development Goals).

This application is based upon and claims the benefit of priorities from Japanese patent application No. 2023-051761, filed on Mar. 28, 2023, and Japanese patent application No. 2023-189029, filed on Nov. 6, 2023, the disclosures of which are incorporated herein in their entireties by reference.

### REFERENCE SIGNS LIST

1 SPRAYING AGENT
110 SEED
120 SOIL

1-16. (canceled)

17. A spraying agent comprising:
a resin emulsion, used for at least one of agglomeration of soil, immobilization of seeds or plants, and immobilization of a chemical agent, and
the resin emulsion comprises a biodegradable resin containing an ester skeleton and having a minimum film-forming temperature of 30° C. or lower.

18. The spraying agent according to claim 17, wherein the biodegradable resin contains a reaction product of a plurality of raw materials including biodegradable polyester polyol and polyisocyanate.

19. The spraying agent according to claim 18, wherein the biodegradable polyester polyol includes aliphatic polyester polyol obtained by ring-opening polymerization of a biodegradable cyclic ester.

20. The spraying agent according to claim 19, wherein the cyclic ester is one or more types selected from the group consisting of lactones and cyclic diesters.

21. The spraying agent according to claim 20, wherein
the lactones are one or more types selected from the group consisting of: β-propiolactone, β-butyrolactone, γ-butyrolactone, γ-hexanolactone, γ-octanolactone, δ-valerolactone, γ-valerolactone, δ-hexalanolactone, δ-octanolactone, ε-caprolactone, δ-dodecanolactone, α-methyl-γ-butyrolactone, β-methyl-δ-valerolactone, glycolide, and p-dioxanone, and
the cyclic diesters are one or more types selected from the group consisting of: D-lactide, L-lactide, DL-lactide, and mesolactide.

22. The spraying agent according to claim 17, wherein a ratio of the biodegradable resin in 100 mass % of resin components of the resin emulsion is 1 to 100 mass %.

23. The spraying agent according to claim 17, wherein a breaking strength of a film of the biodegradable resin is 0.05 to 45 MPa.

24. The spraying agent according to claim 17, wherein a breaking elongation of a film of the biodegradable resin is 50 to 2,000%.

25. The spraying agent according to claim 17, wherein a breaking strength retention rate of a film of the biodegradable resin is 70% or higher after the film is left for 20 days under an environment having a temperature of 40° C. and a humidity of 85%.

26. The spraying agent according to claim 17, wherein in the immobilization, the spraying agent is applied to at least one of soil, a tree, and a wall.

27. The spraying agent according to claim 17, wherein the chemical agent is at least one of a pesticide, a growth regulator, an herbicide, an insect repellent, and a flame retardant.

28. A resin sheet formed of a resin composition comprising a resin emulsion for at least one of agglomeration of soil, immobilization of seeds or plants, and immobilization of a chemical agent, wherein
the resin emulsion comprises a biodegradable resin containing an ester skeleton and having a minimum film-forming temperature of 30° C. or lower.

29. The resin sheet according to claim 28, wherein the biodegradable resin contains a reaction product of a plurality of raw materials including biodegradable polyester polyol and polyisocyanate.

30. The resin sheet according to claim 29, wherein the biodegradable polyester polyol includes aliphatic polyester polyol obtained by ring-opening polymerization of a biodegradable cyclic ester.

31. The resin sheet according to claim 30, wherein the cyclic ester is one or more types selected from the group consisting of lactones and cyclic diesters.

32. The resin sheet according to claim 31, wherein
the lactones are one or more types selected from the group consisting of: β-propiolactone, β-butyrolactone, γ-butyrolactone, γ-hexanolactone, γ-octanolactone, δ-valerolactone, γ-valerolactone, δ-hexalanolactone, δ-octanolactone, ε-caprolactone, δ-dodecanolactone, α-methyl-γ-butyrolactone, β-methyl-δ-valerolactone, glycolide, and p-dioxanone, and
the cyclic diesters are one or more types selected from the group consisting: of D-lactide, L-lactide, DL-lactide, and mesolactide.
